(19) United States
(12) Patent Application Publication
(10) Pub. No.: US 2026/0368284 A1
(43) Pub. Date: Nov. 19, 2026

(54) Efficient Techniques to Identify the Most Influential Nodes in Graph Structures

(71) Applicant: International Business Machines Corporation, Armonk, NY (US)

(72) Inventors: Lior HORESH, North Salem, NY (US); Shashanka UBARU, Ossining, NY (US); Vasileios KALANTZIS, Nyack, NY (US); Georgios KOLLIAS, White Plains, NY (US)

(21) Appl. No.: 18/611,255

(22) Filed: Mar. 20, 2024

(51) Int. Cl. G06F 18/20

(52) U.S. Cl. CPC G06F 18/29

(57) ABSTRACT

Techniques for improved identification of influential nodes in graph structures are provided. A request to identify a set of influential nodes in a graph comprising a plurality of nodes and a plurality of edges is received, where the request indicates a requested number of most influential nodes. The set of influential nodes is identified based on iteratively generating partial centrality scores, using an incrementing depth hyperparameter, for at least a subset of nodes from the plurality of nodes, and removing nodes from the subset of nodes based on the partial centrality scores, until a size of the subset of nodes is equal to or less than the requested number of most influential nodes. In response to determining that the size of the subset of nodes is equal to or less than the requested number of most influential nodes, the subset of nodes is output.

### BACKGROUND

The present disclosure relates to graph analysis, and more specifically, to evaluating graph structures to identify the most influential nodes.

Graph structures can be used to facilitate the study or evaluation of a wide variety of objects, along with the various relationships between such objects. Graph theory and structures are generally applicable to a wide variety of tasks and problems, such as flow problems, shortest path problems, graph coloring problems, ranking problems, and the like. For example, a graph representing air travel may be created where the nodes represent airports and the edges represent routes or flights between the airports. Such a graph may be evaluated to perform a wide variety of tasks, such as to optimize flow (e.g., optimize the number of passengers that can be transported), to identify the most important or influential airports and/or routes, and the like.

In some cases, identifying the most influential nodes in a graph is referred to as graph centrality. Centrality is a highly useful concept in identifying important nodes in a graph, and is often used to measure the importance (or “centrality,” as in how “central” a node is in the graph) of various nodes in the graph. There are a variety of measures, commonly referred to as centrality measures, which can be used to quantify the relative importance of each node. However, existing centrality measures are generally highly computationally complex, particularly as the size and complexity of the graph increases. Unfortunately, large and complex graphs are often the most important or relevant ones today (e.g., representing roads between cities, molecular connections, and the like). As a result, determining the most influential nodes in graphs is generally a computationally expensive and time-consuming process using conventional approaches.

### SUMMARY

According to one embodiment of the present disclosure, a method is provided. The method includes receiving a request to identify a set of influential nodes in a graph comprising a plurality of nodes and a plurality of edges, wherein the request indicates a requested number of most influential nodes; identifying the set of influential nodes based on iteratively: generating partial centrality scores, using an incrementing depth hyperparameter, for at least a subset of nodes from the plurality of nodes; and removing nodes from the subset of nodes based on the partial centrality scores, until a size of the subset of nodes is equal to or less than the requested number of most influential nodes; and in response to determining that the size of the subset of nodes is equal to or less than the requested number of most influential nodes, outputting the subset of nodes.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs that, when executed by the one or more computer processors, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example system for efficiently identifying influential nodes in graph structures, according to some embodiments of the present disclosure.

FIG. 3 depicts an example workflow for efficiently identifying influential nodes in graph structures, according to some embodiments of the present disclosure.

FIG. 4 is a flow diagram depicting an example method for efficiently identifying influential nodes in graph structures, according to some embodiments of the present disclosure.

FIG. 5 is a flow diagram depicting an example method for identifying influential nodes in a graph, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DETAILED DESCRIPTION

Embodiments of the present disclosure provide efficient techniques to identify the most influential nodes in graph structures.

In some embodiments, techniques are provided to specifically identify the top-N most influential nodes of a graph, where N may be defined by the requesting entity (e.g., a user or other application), or may be set to a dynamic or fixed value. In some embodiments, each node of the input graph is associated with a centrality score (e.g., a real positive scalar value) which indicates the importance or influence of the node. The nodes associated with the highest (e.g., the top-N) indices may be referred to as the most influential nodes in the graph.

In some embodiments, different applications and tasks may benefit from different centrality measures that focus on different qualitative aspects of the graphs. In some embodiments, therefore, the choice of the appropriate centrality measure may be an application-specific decision. In some examples discussed herein, subgraph centrality is used as the centrality measure. However, in embodiments, any suitable centrality measure may be used depending on the particular implementation. Subgraph centrality is a widely-used centrality measure in the analysis of complex networks from a diverse range of applications, including biology, neuroscience, and economics. In some embodiments, the subgraph centrality measure is better able to discriminate the nodes of a network (e.g., to identify the nodes that are truly most influential) than a variety of alternate measures such as degree centrality, closeness centrality, betweenness centrality, and/or eigenvector centrality. For example, in some embodiments, subgraph centrality gives more weight to smaller subgraphs (as compared to larger ones), thus making subgraph centrality a good measure for understanding network motifs in many common tasks.

In embodiments of the present disclosure, the system uses an iterative operation to generate partial subgraph centrality scores for each node in the graph and identify node(s) to cull or remove from further evaluation based on the most-recent partial subgraph centrality scores (e.g., nodes which will not be in the top N set of most influential nodes). After pruning such nodes from the set, the process can be repeated until the set of remaining nodes is equal to or less than N.

For example, in some embodiments, the system computes additional eigenpairs of the symmetric adjacency matrix for the graph until the nodes with the highest N (partial) subgraph centrality scores are identified. In some embodiments, the resulting set of most influential nodes may not be perfectly ranked within the list. That is, the set contains the N most influential nodes, but the N nodes in the set may be unranked with respect to each other. In some embodiments, the set of most influential nodes may have an imperfect ranking or ordering, such as where the nodes are roughly ordered (e.g., the first node is substantially likely to be more important than the N-th node and node influence generally decreases along the ordering, though some nodes may be at least somewhat out of order).

In some embodiments, by performing a series of sparse matrix-vector products with the symmetric adjacency matrix until the termination criteria are met, the most influential nodes can be identified with considerably fewer computational resources than alternative approaches for the same task. For example, Gaussian quadrature approaches require a number of sparse matrix-vector products that are proportional to the number of nodes in the graph (which can be highly computationally expensive, particularly for large graphs). The techniques described herein may be, in the worst case, as expensive as matrix diagonalization when the complete set of eigenpairs must be computed to find the most influential nodes. However, the subgraph centrality measure exponentiates the eigenvalues of the graph, thus making the contribution of all but the few dominant eigenpairs marginal. Therefore, using embodiments disclosed herein, only a small gap in the spectrum of the adjacency matrix is generally more than sufficient to conclusively identify the most influential nodes after computing only a few dominant eigenpairs (e.g., the first few pairs), as discussed in more detail below. In this way, the techniques described herein can identify the most influential nodes with substantially reduced computational complexity.

Generally, embodiments of the present disclosure can be used to perform or facilitate a wide variety of tasks. For example, suppose one desires to predict essential genes using protein interactions and gene expression data. Protein interaction data (e.g., interactions derived or determined using approaches such as yeast two-hybrid, affinity chromatography, co-immunoprecipitation, and the like) can be used to create a protein-protein interaction (PPI) network (e.g., a graph). In such a PPI network, the nodes may represent proteins and the edges connecting those proteins may indicate interaction partners.

The centrality-lethality hypothesis in yeast PPI networks states that gene knockouts of genes representing hub proteins (e.g., a protein interacting with many other proteins) in the PPI network are more likely to be lethal for the organism. This finding has been verified in over fifteen organisms. For detection of essential genes and proteins, substantial research effort has been focused on finding a single measure that can optimally rank the essential proteins based on network topology of the PPI. In some cases, the node centrality analysis described herein can provide a fast and reproducible way to rank the nodes based on their location in the graph. That is, the node ranking techniques described herein will give higher rank to essential proteins and lower rank to nonessential ones.

That is, rather than simply evaluating the number of links per node, the rankings provided using subgraph centrality may be highly correlated with the lethality of the proteins. Therefore, one example use for the improved node centrality techniques described herein is to efficiently identify the most influential proteins, which enables identification of the most lethal gene knockouts (e.g., removing genes that produce those influential proteins) to a variety of organisms.

As discussed above, aspects of the present disclosure can readily be applied to a wide variety of other tasks, such as identifying the most influential or important software and/or hardware components in computing systems, identifying the most important nodes in a communications network (e.g., the Internet), identifying the most important cities or hubs in a transportation network (e.g., airports, railyards, and the like), identifying the most influential or important users or individuals in a community or organization, and the like.

Once the most influential or important entities are discovered, a wide variety of actions can be taken, depending on the particular task. For example, medications may be designed to target the most influential genes or proteins of invasive or harmful agents. As another example, redundancy or enhanced security may be added to the most important nodes in a communication or transportation network. Generally, the embodiments described herein may be applied to a wide variety of tasks to enable a wide variety of solutions and improvements using substantially fewer computational resources (e.g., less power consumption, less memory usage, reduced latency, reduced compute cycles, and the like).

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

### Example Computing Environment

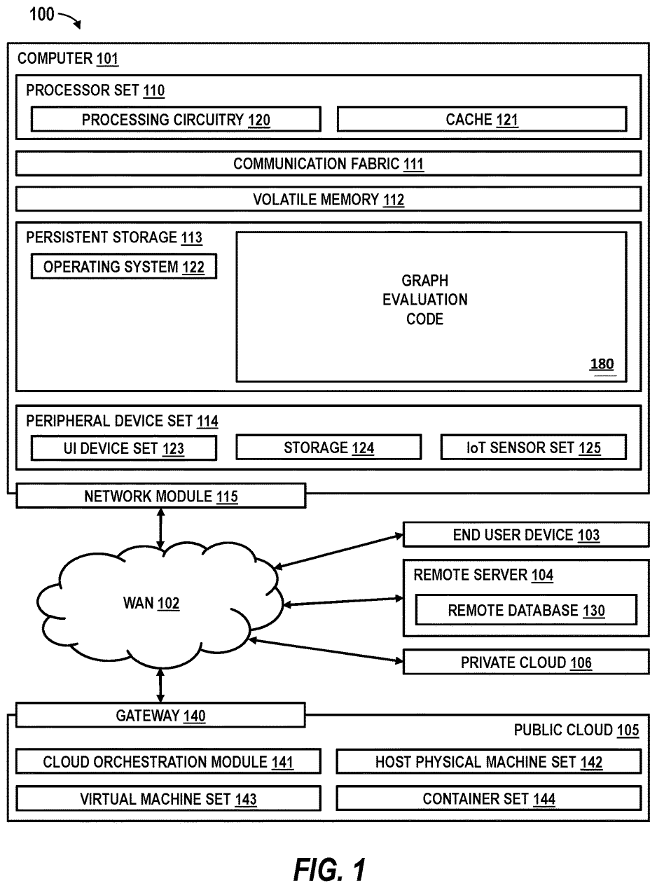

FIG. 1 depicts an example computing environment 100 for the execution of at least some of the computer code involved in performing the inventive methods.

Computing environment 100 contains an example of an environment for the execution of at least some of the computer code involved in performing the inventive methods, such as graph evaluation code 180. In addition to graph evaluation code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and graph evaluation code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in graph evaluation code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in graph evaluation code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System for Efficiently Identifying Influential Nodes in Graph Structures

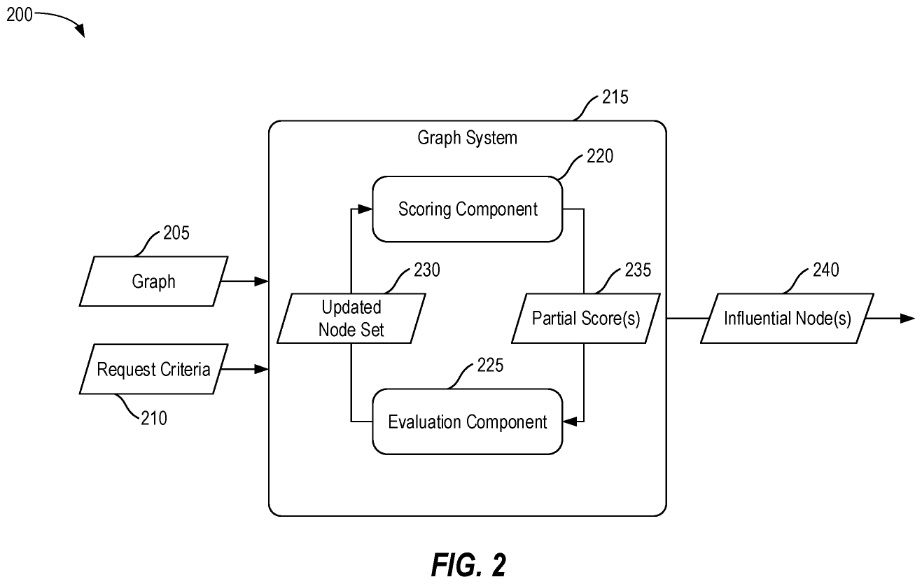

FIG. 2 depicts an example system 200 for efficiently identifying influential nodes in graph structures, according to some embodiments of the present disclosure.

In the illustrated example, a graph system 215 accesses a graph 205 and a set of request criteria 210. As used herein, “accessing” data may generally include receiving, requesting, retrieving, obtaining, generating, collecting, or otherwise gaining access to the data. For example, the graph 205 and request criteria 210 may be provided by a user or other requesting entity. Though depicted as a discrete system for conceptual clarity, in some embodiments, the operations of the graph system 215 may be combined or distributed across any number of components, and may be implemented using hardware, software, or a combination of hardware and software. In some embodiments, the graph system 215 may correspond to the graph evaluation code 180 of FIG. 1.

In some embodiments, the graph 205 generally corresponds to a graph structure comprising a set of nodes and a set of edges. As discussed above, the graph 205 may represent a wide variety of data depending on the particular implementation. Generally, the nodes of the graph 205 represent the relevant entities and the edges represent the relevant relationships among the entities. For example, as discussed above, the nodes may represent cities or transportation hubs while the edges represent transportation links (e.g., flight paths, roads, railroads, and the like). As another example, the nodes may represent proteins, genes, and/or chemicals, and the edges may represent interactions between the proteins, genes, and/or chemicals. In some embodiments, the graph 205 may be curated or generated based on a wide variety of data (including manually specified data, such as user-indicated relationships, and/or automatically identified data).

In the illustrated example, the request criteria 210 may include any relevant information to provide context or detail for the requested information. For example, the request criteria 210 may specify the number of influential nodes that are desired (e.g., requesting a list of the top N most influential nodes). In some embodiments, rather than specifying the request criteria 210, the graph system 215 may use a defined or fixed value for N.

In the depicted example, the graph system 215 comprises a scoring component 220 and an evaluation component 225. Though depicted as discrete components for conceptual clarity, in some embodiments, the operations of the scoring component 220 and the evaluation component 225 may be combined or distributed across any number of components. In the illustrated system 200, the scoring component 220 evaluates the graph 205 to generate partial scores 235 for one or more nodes in the graph 205. The partial scores 235 are generally representative of a partial centrality measure (e.g., partial subgraph centrality) for the node(s). For example, many centrality measures involve iterative or sequential evaluation of nodes and/or edges to quantify the centrality of a node (e.g., iteratively or sequentially evaluating each edge and/or path that connects to the node). In some embodiments, the partial scores 235 may represent the centrality score of the node(s) after performing a subset of these evaluations (e.g., evaluating a subset of the edges or paths, such as after evaluating a single path).

For example, in some embodiments, the subgraph centrality score of a given node in the graph 205 is defined as the sum of weighted closed paths (e.g., loops) of all lengths that start and end at the given node. In some embodiments, the loops are weighted based on the path length (e.g., where weight of a loop is inversely proportional to the path length, such that longer path lengths have lower weights in computing the centrality score for the node). In some embodiments, the subgraph centrality score is generated based on the eigenvalues and eigenvectors of the adjacency matrix for the graph 205. For example, in some embodiments, the subgraph centrality score SC of a given node i in the graph 205 may be defined using Equation 1 below, where n is the number of nodes in the graph 205, and (λⱼ, x^{(j)} is the j-th eigenpair of the n×n adjacency matrix for the graph 205 (e.g., where λⱼ is the j-th algebraically largest eigenvalue for the graph 205 and

$${x}_{i}^{j}$$

is the i-th entry of the j-th eigenvector).

$$S C ( i ) = {\sum }_{j = 1}^{j = n} {e}^{{λ}_{j}} {x}_{i}^{( j ) 2} \qquad ( 1 )$$

In some embodiments, the subgraph centrality of a given node may alternatively be defined using Equation 2 below, where A is the adjacency matrix for the graph 205.

$$S C ( i ) = {\sum }_{j = 0}^{j = ∞} \frac{{A}_{i i}^{j}}{j !} \qquad ( 2 )$$

In some embodiments, to generate a partial centrality score (e.g., based on the first k eigenpairs of A), the partial subgraph centrality (e.g., partial scores 235) may be defined using Equation 3 below.

$$S {C}_{k} ( i ) = {\sum }_{j = 1}^{j = k} {e}^{{λ}_{j}} {x}_{i}^{( j ) 2} \qquad ( 3 )$$

In the illustrated embodiment, after computing partial scores 235 for one or more nodes in the graph 205, the evaluation component 225 evaluates the partial scores 235 to generate an updated node set 230. Generally, the evaluation component 225 generates the updated node set 230 by removing any nodes, from the total set of nodes, that cannot be the most influential (based on the partial scores 235). That is, as the partial scores 235 increase by smaller amounts for each subsequent iteration (e.g., where the increase for the 1st iteration is higher than the increase for the second, and so on), the evaluation component 225 may determine or infer, based on the most recent batch of partial scores 235, that one or more nodes cannot possibly be in the top N most influential set (e.g., because the most recent increase is insufficient to overcome the current N-th most influential node), as discussed in more detail below.

In some embodiments, during the first iteration, the scoring component 220 generates a respective partial score 235 for each respective node in the graph 205 beginning with a first value of k (e.g., k=1) (e.g., using Equation 3). In some embodiments, k is referred to as a depth value or a depth hyperparameter, as it indicates or controls how many eigenpairs are considered when quantifying the centrality score. The evaluation component 225 may then remove any node(s) which cannot be in the top N set, thereby generating the updated node set 230. During subsequent iterations, the scoring component 220 increments k and evaluates the updated node set 230 (e.g., a subset of the nodes in the graph 205) to generate new partial scores 235 for the increased depth (e.g., for k+1). This process may be repeated until the size of the updated node set 230 is equal to or less than N (e.g., until all except for the top N nodes have been removed from the set). This final updated node set 230 is then output as the influential nodes 240. That is, the influential nodes 240 may correspond to a list of nodes, from the graph 205, which are the most influential (as determined using partial centrality scores).

More specifically, suppose the set of top-N ranked nodes from the graph 205 after computing k−1 eigenpairs of A is defined as

$${𝒥}_{k - 1}^{( N )} .$$

After the scoring component 220 generates the partial scores 235 for a depth of k (e.g., computing the eigenpair (λₖ, x^{(k)}, the evaluation component 225 can determine that a given node i is not in the set of the top N most influential nodes if Equation 4 is true for the node i.

$${\sum }_{j = 1}^{j = k - 1} {e}^{{λ}_{j}} {x}_{i}^{( j ) 2} + ( 1 - {\sum }_{j = 1}^{j = k - 1} {x}_{i}^{( j ) 2} ) {e}^{{λ}_{k} <} \begin{matrix}min \\ t ∈ {𝒥}_{k - 1}^{( N )}\end{matrix} {\sum }_{j = 1}^{j = k - 1} {e}^{{λ}_{j}} {x}_{t}^{( j ) 2} \qquad ( 4 )$$

That is, because eigenvectors are orthogonal, the partial score 235 of the node i cannot increase by more than

$$( 1 - {\sum }_{j = 1}^{j = k - 1} {x}_{i}^{( j ) 2} ) {e}^{{λ}_{k}} .$$

Thus, if the sum of this increase is less than the minimum score in the top N nodes, the evaluation component 225 can determine that the node i cannot be in the top N. The evaluation component 225 may therefore exclude or remove the node i from the updated node set 230. That is, the graph system 215 may stop evaluating the node i. Therefore, as the size of the updated node set 230 is reduced iteratively, the computational expense of the graph system 215 is reduced. Further, as the graph system 215 generally finds the top N nodes for relatively small values of k (e.g., significantly smaller than evaluating the entire graph to generate a full centrality score), the set of influential nodes 240 can be identified with substantially reduced computational expense, as compared to conventional approaches.

As discussed above, the set of influential nodes 240 may generally be used for a wide variety of purposes, depending on the particular task and implementation. For example, as discussed above, the graph system 215 may output the influential nodes 240 and/or facilitate use of the influential nodes 240 to perform operations such as automatically increasing redundancy of the influential nodes 240 (e.g., in computing or communication systems), suggesting that clinicians target the proteins or genes represented by the identified influential nodes 240 when designing medications, and the like. As used herein, “facilitating” use of the influential nodes 240 may include actually performing the action (e.g., where the graph system 215 itself implements the improvement, such as by automatically introducing redundancy to software components) as well as indicating the nodes and/or actions for other users or systems to implement.

### Example Workflow for Efficiently Identifying Influential Nodes in Graph Structures

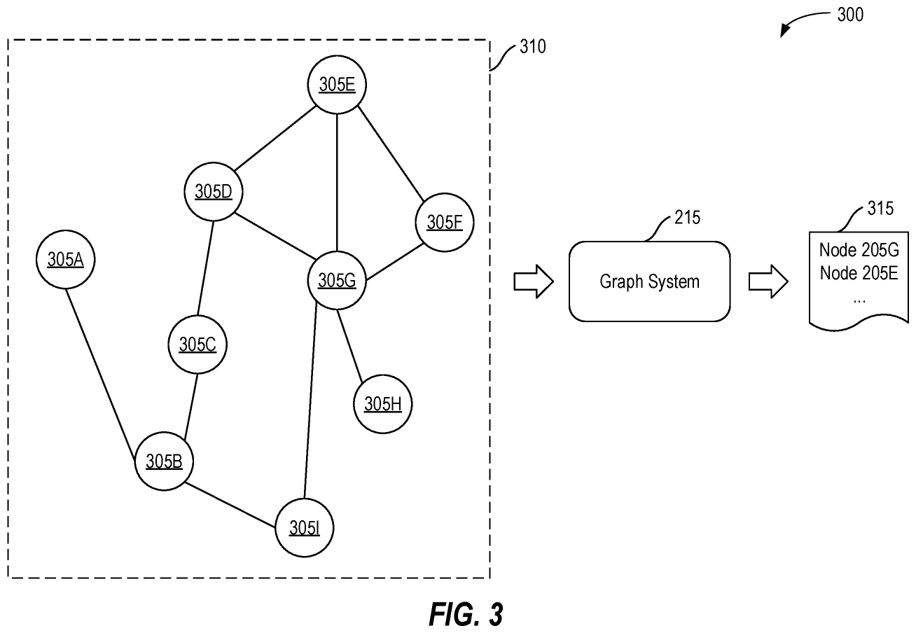

FIG. 3 depicts an example workflow 300 for efficiently identifying influential nodes in graph structures, according to some embodiments of the present disclosure.

In the illustrated workflow 300, the graph system 215 evaluates a graph 310 (which may correspond to the graph 205 of FIG. 2) to generate a set of influential nodes 315 (e.g., the influential nodes 240 of FIG. 2). As illustrated, the graph 310 includes a set of nodes 305A-I, with various edges interconnecting the nodes 305. For example, the node 305A is connected to the node 305B via an edge, and the node 305B is connected to the nodes 305C and 305I via respective edges. In some embodiments, some or all of the edges are undirected edges (e.g., the edges go both ways and do not have a direction). In some embodiments, some or all of the edges are directed edges (e.g., with a direction from a start node to an end node, where the direction indicates some characteristic of the relationship between the nodes).

Although the illustrated graph 310 is relatively simple for conceptual clarity (e.g., having only nine nodes 305), as discussed above, the graphs may be substantially more complex in realistic implementations (e.g., with hundreds, thousands, or millions of nodes and edges). As illustrated, the set of most influential nodes 315 includes, for example, the Node 205G, the Node 205E, and so on. As discussed above, the node influence may generally be defined based on a (partial) centrality score for each node. For example, as discussed above, the graph system 215 may generate partial centrality scores for the nodes 305 iteratively, excluding nodes that no longer have the possibility to enter the top N, until the top N set of nodes is found. As an example, in the illustrated graph 310, the nodes 305A has no loops that begin and terminate at the node 305A. The node 305H is similarly situated. As a result, the nodes 305A and 305H have subgraph centrality scores of zero. As there are other node(s) having loops (which result in a positive non-zero score), the graph system 215 may determine that the nodes 305A and 305H should be eliminated from further consideration during the first iteration of evaluation (unless N is greater than or equal to eight or nine, covering all nodes in the graph).

As another example, the node 305G has several loops that begin and terminate at the node 305G, including the path from node 305G to 305D, then to the node 305E, and then back to the node 305G, as well as the path from the node 305G to the node 305D, then to the node 305E, then to the node 305F, then back to the node 305G, and so on. In the illustrated example, due to these multiple paths of varying lengths, the graph system 215 determines that the node 205G is the most influential (or is at least in the top N set of most influential nodes) based on its partial centrality score.

As discussed above, in some embodiments, the set of influential nodes 315 is unordered (or may be at least partially unordered). That is, although the set of influential nodes 315 definitively includes the N most influential nodes in the graph 310 (as defined by the partial subgraph centrality scores), the set itself may not be in perfect order of influence (e.g., the node 205E may be more influential than the node 205G).

### Example Method for Efficiently Identifying Influential Nodes in Graph Structures

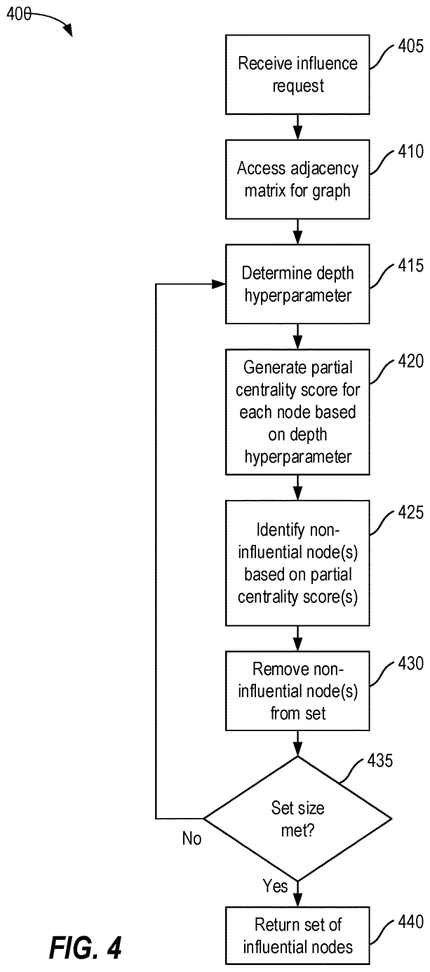

FIG. 4 is a flow diagram depicting an example method 400 for efficiently identifying influential nodes in graph structures, according to some embodiments of the present disclosure. In some embodiments, the method 400 is performed by a graph system, such as the graph evaluation code 180 of FIG. 1 and/or graph system 215 of FIGS. 2-3.

At block 405, the graph system receives an influence request to generate a set of the most influential nodes in a graph. That is, the graph system receives a request (e.g., from a user or from another system), where the request includes (or points to) a graph (e.g., the graph 205 of FIG. 2 and/or the graph 310 of FIG. 3) having a set of nodes and a set of edges, and requests that the graph system generate or identify a set of the most influential nodes in the graph. In some embodiments, as discussed above, the request specifies the requested number of most influential nodes (e.g., the desired size of the set). In some embodiments, the graph system may use a predefined or fixed number of nodes. In some embodiments, the desired number of nodes is defined based on the graph size, rather than as a discrete value (e.g., to identify the top N % of nodes in the graph, rather than the top N). Generally, for many realistic uses, the desired number of influential nodes is substantially smaller than the total number of nodes in the graph.

At block 410, the graph system accesses (or generates) an adjacency matrix for the graph. In some embodiments, the adjacency matrix is a matrix of size n×n (for a graph having n nodes), where each column and row corresponds to one of the n nodes, and each element in the adjacency matrix (e.g., each intersection of a column and row) contains a defined value (e.g., one) only if the corresponding nodes (the nodes corresponding to the column and row) are adjacent in the graph (e.g., having an edge linking the nodes). In some aspects, as discussed above, the adjacency matrix is used to generate centrality scores for the nodes (e.g., to evaluate eigenpairs for subgraph centrality). In some aspects, for other centrality measures or techniques that do not rely on the adjacency matrix of the graph, block 410 may be bypassed.

At block 415, the graph system determines a depth hyperparameter. For example, as discussed above, the graph system may begin with a depth of one in the first iteration. As discussed above, the depth hyperparameter may generally indicate the current depth (e.g., number of iterations) of the partial centrality scores for the nodes.

At block 420, the graph system generates a respective partial centrality score for each respective node based on the current value of the depth hyperparameter. For example, as discussed above, the graph system may generate the partial centrality score for each given node using Equation 3 above. In some embodiments, as discussed above, the graph system may generate a partial centrality score for each node in a current set of most influential nodes, where the graph system iteratively removes nodes from the set based on the updated scores. During the first iteration, the set may include all nodes in the graph, as discussed above. In some embodiments, as discussed above, the graph system generates the partial centrality score using partial subgraph centrality based on the adjacency matrix, as discussed above.

At block 425, the graph system identifies non-influential nodes (if any) in the current set of influential nodes based on the partial centrality scores. For example, as discussed above, the non-influential nodes may correspond to nodes with partial centrality scores below a threshold amount and/or that increased less than a threshold amount at block 420. For example, as the next evaluation is guaranteed to result in an increase that is not greater than the current increase, the graph system may determine whether the current maximum potential increase would cause the node to enter the top N nodes. If not, it is impossible for the given node to ever enter the top N, and the graph system may classify it as a non-influential node.

At block 430, the graph system removes any identified non-influential node(s) from the current set of influential nodes. As discussed above, removing the nodes from the set may generally correspond to generating a new set that excludes the node(s) (but includes any other nodes which satisfied the criteria at block 425), removing the nodes from the set, and/or otherwise refraining from further evaluation of the non-influential nodes.

At block 435, the graph system determines whether the set size criteria is met. For example, after removing the non-influential nodes, the graph system may determine whether the size of the current set of influential nodes is equal to or less than the desired or requested number of influential nodes. If so, the method 400 continues to block 440, where the graph system returns or outputs the set of influential nodes.

If not, the method 400 returns to block 415. In some embodiments, as discussed above, the graph system may increment the depth hyperparameter (e.g., at block 415) and generate a new set of partial centrality scores using the updated depth. In this way, the graph system can iteratively generate more refined partial centrality scores (using iteratively more compute resources) until the set of influential nodes meets the desired size.

### Example Method for Identifying Influential Nodes in a Graph

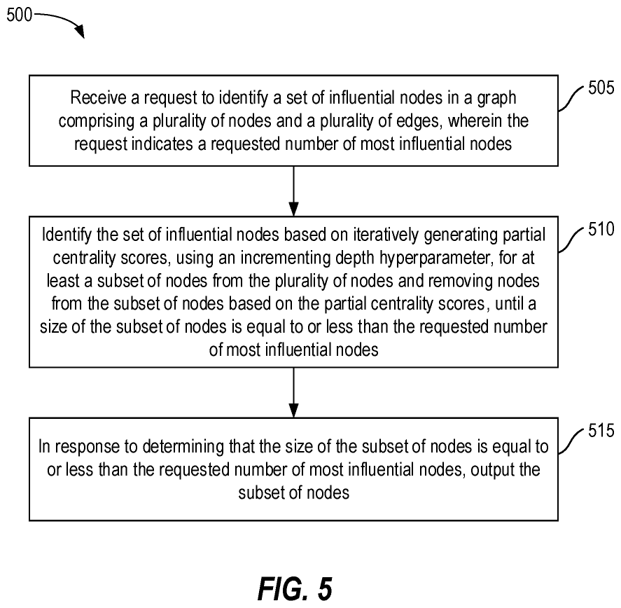

FIG. 5 is a flow diagram depicting an example method 500 for identifying influential nodes in a graph, according to some embodiments of the present disclosure. In some embodiments, the method 500 is performed by a graph system, such as the graph evaluation code 180 of FIG. 1 and/or graph system 215 of FIGS. 2-3.

At block 505, a request to identify a set of influential nodes (e.g., the influential nodes 240 of FIG. 2 and/or the influential nodes 315 of FIG. 3) in a graph (e.g., the graph 205 of FIG. 2 and/or the graph 310 of FIG. 3) comprising a plurality of nodes and a plurality of edges is received, wherein the request indicates a requested number of most influential nodes (e.g., in the request criteria 210 of FIG. 2).

At block 510, the set of influential nodes is identified based on iteratively generating partial centrality scores (e.g., the partial scores 235 of FIG. 2), using an incrementing depth hyperparameter, for at least a subset of nodes from the plurality of nodes and removing nodes from the subset of nodes based on the partial centrality scores (e.g., to generate an updated node set 230 of FIG. 2), until a size of the subset of nodes is equal to or less than the requested number of most influential nodes.

At block 515, in response to determining that the size of the subset of nodes is equal to or less than the requested number of most influential nodes, outputting the subset of nodes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing is directed to embodiments of the present invention, other and further embodiments of the invention may be devised without departing from the basic scope thereof, and the scope thereof is determined by the claims that follow.

What is claimed is:

1. A method, comprising:
receiving a request to identify a set of influential nodes in a graph comprising a plurality of nodes and a plurality of edges, wherein the request indicates a requested number of most influential nodes;
identifying the set of influential nodes based on iteratively:
generating partial centrality scores, using an incrementing depth hyperparameter, for at least a subset of nodes from the plurality of nodes; and
removing nodes from the subset of nodes based on the partial centrality scores, until a size of the subset of nodes is equal to or less than the requested number of most influential nodes; and
in response to determining that the size of the subset of nodes is equal to or less than the requested number of most influential nodes, outputting the subset of nodes.

2. The method of claim 1, wherein identifying the set of influential nodes comprises:
generating, for a first node of the subset of nodes, a first partial centrality score based on the depth hyperparameter; and
in response to determining, based on the first partial centrality score, that the first node is not in the requested number of most influential nodes, removing the first node from the subset of nodes.

3. The method of claim 2, wherein identifying the set of influential nodes further comprises, in response to determining that a size of the subset of nodes is greater than the requested number of most influential nodes, incrementing the depth hyperparameter.

4. The method of claim 3, wherein identifying the set of influential nodes further comprises:
generating, for a second node of the subset of nodes, a second partial centrality score based on the incremented depth hyperparameter; and
in response to determining, based on the second partial centrality score, that the second node is not in the requested number of most influential nodes, removing the second node from the subset of nodes.

5. The method of claim 2, wherein determining that the first node is not in the requested number of most influential nodes comprises determining, based on the first partial centrality score and a prior partial centrality score for the first node, that the partial centrality score of the first node will not exceed a lowest current partial centrality score for the requested number of most influential nodes.

6. The method of claim 1, wherein the set of influential nodes is an unordered set.

7. The method of claim 1, wherein the partial centrality scores correspond to partial subgraph centrality scores.

8. The method of claim 7, wherein a partial subgraph centrality score is defined as
$$S C ( i ) = {\sum }_{j = 1}^{j = k} {e}^{{λ}_{j}} {x}_{i}^{( j ) 2} ,$$
wherein:
SC(i) is a partial subgraph centrality score for an i-th node in the plurality of nodes;
k is the depth hyperparameter;
λⱼ is a j-th eigenvalue for the graph; and
$${x}_{i}^{j}$$
is a j-th eigenvector for the i-th node.

9. A system comprising:
one or more memories collectively storing computer-executable instructions; and
one or more processors configured to collectively execute the computer-executable instructions and cause the system to perform an operation comprising:
receiving a request to identify a set of influential nodes in a graph comprising a plurality of nodes and a plurality of edges, wherein the request indicates a requested number of most influential nodes;
identifying the set of influential nodes based on iteratively:
generating partial centrality scores, using an incrementing depth hyperparameter, for at least a subset of nodes from the plurality of nodes; and
removing nodes from the subset of nodes based on the partial centrality scores, until a size of the subset of nodes is equal to or less than the requested number of most influential nodes; and
in response to determining that the size of the subset of nodes is equal to or less than the requested number of most influential nodes, outputting the subset of nodes.

10. The system of claim 9, wherein identifying the set of influential nodes comprises:
generating, for a first node of the subset of nodes, a first partial centrality score based on the depth hyperparameter; and
in response to determining, based on the first partial centrality score, that the first node is not in the requested number of most influential nodes, removing the first node from the subset of nodes.

11. The system of claim 10, wherein identifying the set of influential nodes further comprises, in response to determining that a size of the subset of nodes is greater than the requested number of most influential nodes, incrementing the depth hyperparameter.

12. The system of claim 11, wherein identifying the set of influential nodes further comprises:
generating, for a second node of the subset of nodes, a second partial centrality score based on the incremented depth hyperparameter; and
in response to determining, based on the second partial centrality score, that the second node is not in the requested number of most influential nodes, removing the second node from the subset of nodes.

13. The system of claim 10, wherein determining that the first node is not in the requested number of most influential nodes comprises determining, based on the first partial centrality score and a prior partial centrality score for the first node, that the partial centrality score of the first node will not exceed a lowest current partial centrality score for the requested number of most influential nodes.

14. The system of claim 9, wherein the set of influential nodes is an unordered set.

15. A computer program product, comprising a computer-readable storage medium having computer-readable program code executable to cause the computer program product to perform an operation comprising:
receiving a request to identify a set of influential nodes in a graph comprising a plurality of nodes and a plurality of edges, wherein the request indicates a requested number of most influential nodes;
identifying the set of influential nodes based on iteratively:
generating partial centrality scores, using an incrementing depth hyperparameter, for at least a subset of nodes from the plurality of nodes; and
removing nodes from the subset of nodes based on the partial centrality scores, until a size of the subset of nodes is equal to or less than the requested number of most influential nodes; and
in response to determining that the size of the subset of nodes is equal to or less than the requested number of most influential nodes, outputting the subset of nodes.

16. The computer program product of claim 15, wherein identifying the set of influential nodes comprises:
generating, for a first node of the subset of nodes, a first partial centrality score based on the depth hyperparameter; and
in response to determining, based on the first partial centrality score, that the first node is not in the requested number of most influential nodes, removing the first node from the subset of nodes.

17. The computer program product of claim 16, wherein identifying the set of influential nodes further comprises, in response to determining that a size of the subset of nodes is greater than the requested number of most influential nodes, incrementing the depth hyperparameter.

18. The computer program product of claim 17, wherein identifying the set of influential nodes further comprises:
generating, for a second node of the subset of nodes, a second partial centrality score based on the incremented depth hyperparameter; and
in response to determining, based on the second partial centrality score, that the second node is not in the requested number of most influential nodes, removing the second node from the subset of nodes.

19. The computer program product of claim 16, wherein determining that the first node is not in the requested number of most influential nodes comprises determining, based on the first partial centrality score and a prior partial centrality score for the first node, that the partial centrality score of the first node will not exceed a lowest current partial centrality score for the requested number of most influential nodes.

20. The computer program product of claim 15, wherein the set of influential nodes is an unordered set.
